(19) United States
(12) Patent Application Publication
(10) Pub. No.: US 2012/0284785 A1
(43) Pub. Date: Nov. 8, 2012

(54) METHOD FOR FACILITATING ACCESS TO A FIRST ACCESS NEWORK OF A WIRELESS COMMUNICATION SYSTEM, WIRELESS COMMUNICATION DEVICE, AND WIRELESS COMMUNICATION SYSTEM

(75) Inventors: Apostolis K. Salkintzis, Athens (GR); Kenneth A. Stewart, Grayslake, IL (US)

(73) Assignee: MOTOROLA MOBILITY, INC., Libertyville, IL (US)

(21) Appl. No.: 13/101,887

(22) Filed: May 5, 2011

(51) Int. Cl. H04L 9/32; G06F 15/16; G06F 21/00

(52) U.S. Cl. 726/7

(57) ABSTRACT

A method for facilitating access to a first access network (110) of a wireless communication system (100) comprises authenticating (300) a wireless communication device (102) with a second access network (104) and generating temporary access credentials using access information provided by the second access network (104). The wireless communication device (102) then transforms (302) the temporary access credentials and an identifier of the first access network (110) to provide first transformed access credentials which are transmitted (304) for performing authentication with the first access network (110). The identifier of the first access network (110) is provided to the second access network (104) which generates (308) second transformed access credentials using the identifier of the first access network (110) and the temporary access credentials. Authentication is performed (310) with the first access network (110), which includes comparing the first transformed access credentials with the second transformed access credentials and allowing access to the first access network (110) when the first transformed access credentials and the second transformed access credentials are substantially the same. A wireless communication device, and a wireless communication system are also disclosed and claimed.

### FIELD OF THE DISCLOSURE

This disclosure relates to a method for facilitating access to a first access network of a wireless communication system. For example, access to the first access network may be allowed for a wireless communication device and/or for a remote device via a wireless communication device coupled to the remote device. A wireless communication device, and a wireless communication system are also disclosed and claimed.

### BACKGROUND OF THE DISCLOSURE

In order to offload traffic, such as Internet traffic, from Wide Area Networks (WANs), mobile devices can utilize the increasing number of access points (also known as WiFi hotspots) of WiFi networks and transport Internet traffic over WiFi networks. However, in order to offload traffic to the WiFi networks, it is important that mobile devices be able to connect to legacy WiFi hotspots (i.e. access points which have no capability for the Extension Authentication Protocol (EAP)) in a secure way and with minimum or no configuration from the user. This will enable traffic to be offloaded more easily from the Wide Area Networks (WAN) or macro networks, such as UMTS, GSM, GPRS, long-term evolution (LTE) or Wimax networks, to WiFi networks.

In a typical scenario, in order for a 3GPP mobile device (referred to as User Equipment, UE) to connect to a WiFi hotspot, it is desirable for the UE to discover and connect to a new (not preconfigured) WiFi hotspot without any user actions, assuming the WiFi hotspot supports interworking with the UE's home network (e.g. the UE's home UMTS network). In order to roam between the WAN network (e.g. UMTS network) and the WiFi network and connect to a WiFi access point, the UE has to be authenticated with the WiFi network.

The Generic Bootstrapping Architecture (GBA) was specified in 3GPP Release 6 (see 3GPP TS 33.220, the disclosure of which is incorporated herein by reference) as a generic method applied by the UE to secure access to IP bases service, most commonly to HTTP based services. GBA is used after the UE has successfully completed an access authentication: that is, after the UE has attached to the 3GPP network. GBA is composed of two procedures: 1) the bootstrapping procedure in which a bootstrapped security context is created in the UE and the Bootstrapping Server Function (BSF) and 2) the service access procedure in which the UE uses the created bootstrapped security context to securely access a Network Application Function (NAF), such as an HTTP server.

As currently specified, GBA cannot be used for access authentication which includes authenticating a UE for access to a WiFi network. In attempt to address this problem, US patent application publication no. 2010/0242100 describes a network access authentication method which uses a GBA related method. However, this patent application assumes that the password used to authenticate over an access network (e.g. a WiFi network) does not depend on any access network characteristics, which can create security concerns since the same password can be used across many different access networks.

In addition to the GBA related access method described in the above reference patent application, there are other methods known in the prior art that can be used to authenticate a UE for access to a WiFi network. For example, the Extensible Authentication Protocol Method for UMTS Authentication and Key Agreement (EAP-AKA) protocol and the Wireless Internet Service Provider roaming (WISPr) 2.0 protocol specify authentication methods and systems that enable devices to seamlessly authenticate over a WiFi network with Universal Subscriber Identify Module (USIM) credentials (i.e. the users UMTS account is reused to access the WiFi network rather than having to create a new WiFi account). Seamless authentication is when the user is not required to take any action or perform any manual configuration (e.g. to create new WiFi account) and is considered a key enabler of extensive WiFi utilization and offload of macro networks. However, the use of these authentication methods raises some issues.

Firstly, both EAP-AKA and WISPr 2.0 require the WiFi network to provide suitable support. For example, access points (APs) should support EAP and the Remote Authentication Dial In User Service (Radius) protocol (in case of EAP-AKA) and wireless access gateways (WAGs) of the WiFi networks should support EAP-over-HTTP (in case of WISPr 2.0). Legacy WiFi networks typically do not support this functionality and thus, would require upgrading. Without upgrading the legacy WiFi networks to support this functionality, EAP-AKA and WISPr 2.0 cannot be widely deployed to provide seamless WiFi authentication experience.

In addition, EAP-AKA and/or WISPr 2.0 introduce extra implementation complexity in the UEs, which apart from supporting EAP-AKA and/or WISPr 2.0 for WiFi access authentication, are required also to support generic authentication procedures (e.g. GBA) for providing authenticated access to HTTP services. To avoid this complexity in the UEs, it would be beneficial if GBA could be used for both WiFi access authentication and for providing authenticated access to HTTP services in a secure manner.

Furthermore, it is desirable for many different wireless communication devices to be able to seamlessly authenticate and connect to a WiFi hotspot but not all devices (e.g. a portable computer) are equipped with an Universal Integrated Circuit Card (UICC), which is required by EAP-AKA, WISPr 2.0 and the GBA bootstrapping procedure. Typically, such devices require some non-UICC credentials (e.g. a username, password) to be manually configured in the device or be provisioned in the device by some means. This makes it more difficult to attach to a WiFi hotspot without user input.

### BRIEF DESCRIPTION OF THE DRAWINGS

Methods for facilitating access to a first access network of a wireless communication system, a wireless communication device, and a wireless communication system in accordance with different aspects of the disclosure will now be described, by way of example only, with reference to the accompanying drawings in which:

FIG. 1 is a block schematic diagram of a wireless communication system in accordance with an example of an embodiment of the present disclosure;

FIG. 2 is a block schematic diagram of a wireless communication device in accordance with an example of an embodiment of the present disclosure;

FIG. 3 is a flow diagram showing an example method for facilitating access to a first access network via an access point of the first access network in accordance with an embodiment of the disclosure;

FIG. 4 is a diagram showing an example message flow for facilitating access by a wireless communication device to a first access network via an access point of the first access network in accordance with an embodiment of the disclosure;

FIG. 5 is a diagram showing an example message flow for facilitating access by a remote device via a wireless communication device to a first access network via an access point of the first access network in accordance with an embodiment of the disclosure;

FIG. 6 is a diagram showing an example message flow for facilitating access by a wireless communication device to a first access network via an access point of the first access network in accordance with an alternative embodiment of the disclosure; and

FIG. 7 is a diagram showing an example message flow for facilitating access by a remote device via a wireless communication device to a first access network via an access point of the first access network in accordance with an alternative embodiment of the disclosure.

### DETAILED DESCRIPTION OF THE DRAWINGS

The present disclosure will be described with reference to a wireless communication device capable of operating with a first access network and a second access network, with the first access network being a public WiFi network and the second access network being a UMTS network. It will however be appreciated that the present disclosure may apply to other types of networks and wireless communication devices capable of operating with any combination of two or more different networks, which may be selected from, for example: GSM; Enhanced Data rates for GSM Evolution (EDGE); General Packet Radio System (GPRS); CDMA, such as IS-95; WCDMA or Universal Mobile Telecommunications System (UMTS); Fourth Generation Long Term Evolution (LTE); other wide area network communication systems; Private Mobile Radio (PMR); Worldwide Interoperability for Microwave Access (WIMAX); WLAN; or the like, including any network for which the wireless communication device has credentials to access the network. By describing the disclosure with respect to UMTS and WiFi networks, it is not intended to limit the disclosure in any way.

The wireless communication device in accordance with the disclosure may be a portable or mobile telephone, a Personal Digital Assistant (PDA), a wireless video or multimedia device, a portable computer, an embedded communication processor or similar wireless communication device. In the following description, the communication device will be referred to generally as User Equipment (UE) for illustrative purposes and it is not intended to limit the disclosure to any particular type of communication device.

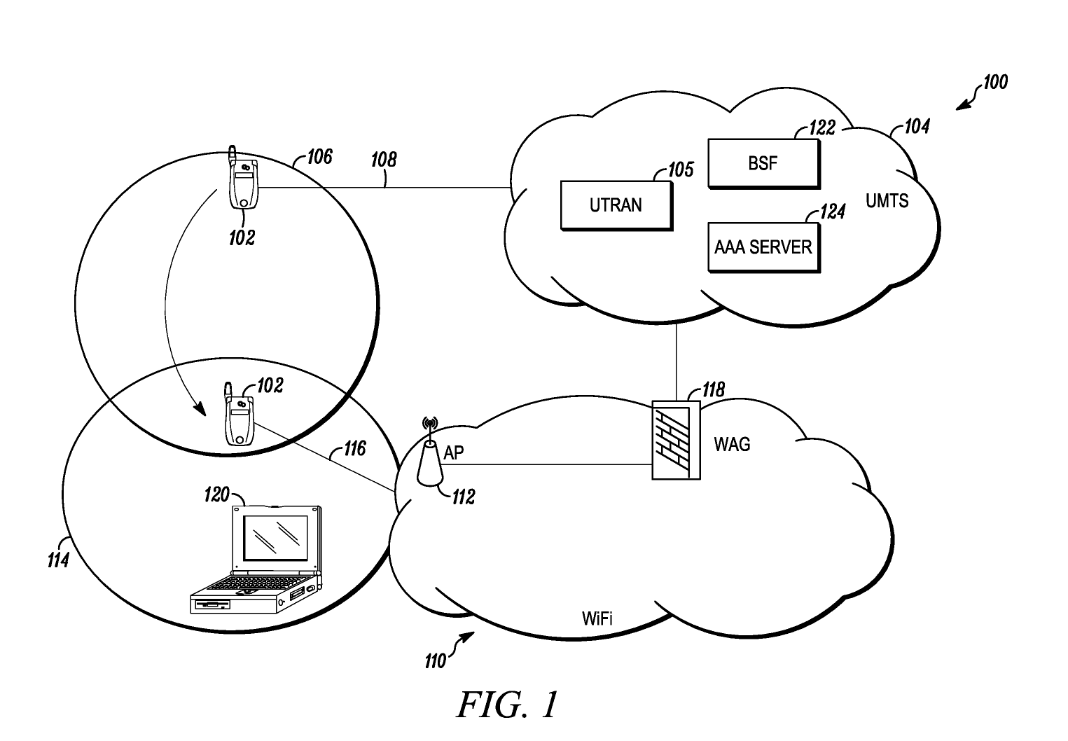

Referring firstly to FIG. 1, a wireless communication system 100 in accordance with an example of an embodiment of the disclosure comprises at least one UE 102 (but typically a plurality of UEs), capable of communicating with a first access network, such as WiFi network 110 and a second access network such as UMTS network 104.

The UMTS network 104 provides a plurality of coverage areas or cells, such as coverage area or cell 106 of UTRAN 105, as is well known in the art. The UE 102 can operate or communicate with the UMTS network 104 via radio communication link 108. The UMTS network 104 includes a Bootstrapping Server Function (BSF) and an Authentication, Authorisation and Accounting (AAA) server 124. The BSF is a functional entity in the UMTS network 104 that is used for creating a bootstrapped security context in the UE (according to GBA specifications; see 3GPP TS 33.220, the disclosure of which is incorporated herein by reference), which can subsequently be used to securely access application servers. The AAA server 124 is a functional entity in the UMTS network 104 and is arranged to perform an access control process which typically includes authenticating and authorising the UE 102 for access to a particular network. In FIG. 1, it is shown that the UE 102 is in a coverage area of its home operator's UMTS network for simplicity (i.e. network 104 is the home network including the home AAA server 124). If UE 102 roams such it is in the coverage area of a visited network, then the visited network would communicate with the home network and the home AAA server in order to authenticate the UE as is well known. The UMTS network 104 is communicatively coupled to one or more other networks (not shown), such as a packet data network, the Internet, a CS network, an IP Multimedia Subsystem (IMS) network, in order to provide services to or from a UE.

The WiFi network 110 provides a coverage area 114 served by at least one access point (AP) 112. The UE 102 can operate or communicate with the WiFi network 110 via radio communication link 116. The WiFi network 110 includes a Wireless Access Gateway (WAG) 118 for communicating with the UMTS network 104 and other networks (e.g. the Internet) which are not shown in FIG. 1 for simplicity. The WAG 118 may be any type of gateway/router that supports authentication of WiFi devices based e.g. on the HTTP and/or the WISPr protocol.

It will be appreciated that although only coverage area 106 is shown in FIG. 1, the UMTS network 104 has a plurality of coverage areas and each coverage area is served by one or more base stations (not shown), known as Node Bs, which are part of the UTRAN 105. In addition, the WiFi network 110 may have a plurality of access points APs.

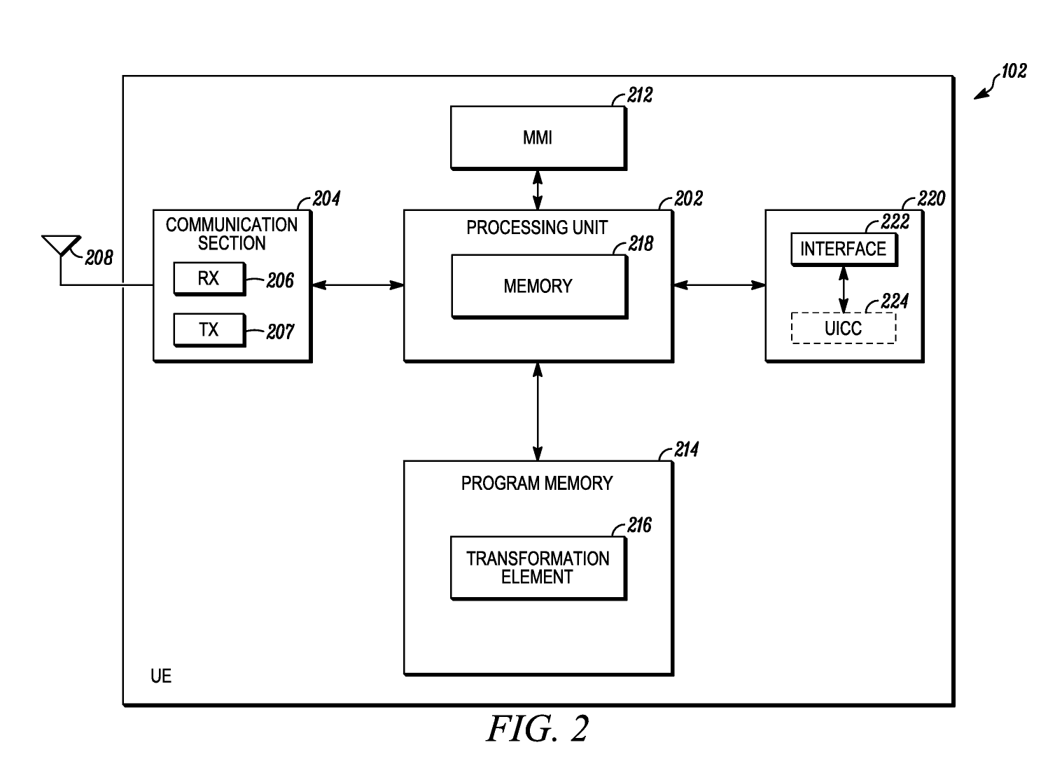

FIG. 2 is a block diagram of a UE, such as UE 102 shown in FIG. 1, in accordance with an embodiment of the disclosure. As will be apparent to a skilled person, FIG. 2 shows only the main functional components of an exemplary UE 102 that are necessary for an understanding of the invention.

The UE 102 comprises a processing unit 202 for carrying out operational processing for the UE 102. The UE 102 also has a communication section 204 for providing wireless communication via a radio communication link with, for example, a Node B (not shown) of the UTRAN 105 of the UMTS network 104 or the AP 112 of the WiFi network 110. The communication section 204 may comprise elements which are part of a UMTS radio interface of the UE 102 and elements which are part of a WiFi radio interface of the UE 102. The communication section 204 typically includes at least one antenna 208, a receiver 206 and a transmitter 207, at least one modulation/demodulation section (not shown), and at least one coding/decoding section (not shown), for example, as will be known to a skilled person and thus will not be described further herein. The communication section 204 may include one set of elements for the UMTS radio interface and one set of elements for the WiFi radio interface or the interfaces may share elements. The communication section 204 is coupled to the processing unit 202.

The UE 102 also has a Man Machine Interface MMI 212, including elements such as a key pad, microphone, speaker, display screen, for providing an interface between the UE and the user of the UE 102. The MMI 212 is also coupled to the processing unit 202.

The processing unit 202 may be a single processor or may comprise two or more processors carrying out all processing required for the operation of the UE 102. The number of processors and the allocation of processing functions to the processing unit is a matter of design choice for a skilled person. The UE 102 also has a program memory 214 in which are stored programs containing processor instructions for operation of the UE 102. The programs may contain a number of different program elements or sub-routines containing processor instructions for a variety of different tasks, for example, for: communicating with the user via the MMI 212; processing signalling messages (e.g. paging signals) received from the UTRAN 105 and WiFi network 110; and performing neighbouring coverage area measurements. Specific program elements stored in program memory 214 include a transformation element 216 for transforming received credentials and facilitating authentication with the WiFi network 110. The operation of the transformation element 216 will be described in more detail below.

The UE 102 may further include a memory 218 for storing information. The memory 218 is shown in FIG. 2 as part of the processing unit 202 but may instead be separate.

The UE 102 further includes an Universal Integrated Circuit Card (UICC) unit 220. The UICC unit 220 is coupled to the processing unit 202 and includes a UICC interface 222 and an UICC. The UICC may be removable and so is represented by the dotted box 224 in FIG. 2. The UICC interface 222 provides an interface between the UICC 224 and the processing unit 202.

The UICC card is the name of the standardised platform that can run several telecom applications such as the USIM application for a 3G network, or the SIM application for a 2G network, or others. The UICC card was introduced with the release 99 of the 3GPP standards, and replaces the SIM platform (that has GSM capabilities only). The term UICC card will be used for the rest of the document to designate the Integrated Circuit Card (ICC) used in a mobile phone for the support of the telecom applications such as USIM, SIM, and ISIM. The UICC 224 stores network specific information used to authenticate and identify the user or subscriber on the UMTS network 104 (and/or other networks) to control access.

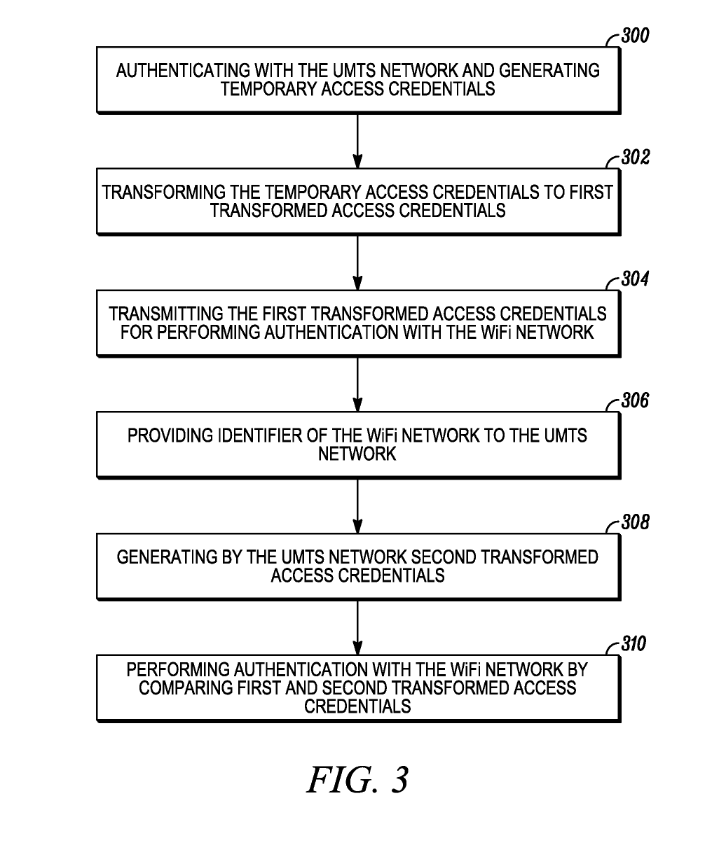

Referring now to FIG. 3 which shows a method for facilitating access to a first access network, such as WiFi network 110, in accordance with an example of an embodiment of the disclosure. The method shall be described with reference to the wireless communication system 100 of FIG. 1 and the UE 102 of FIG. 2 by way of example. It is not intended to limit the invention to these particular types of networks.

In step 300, the UE authenticates with the UMTS network 104 and temporary access credentials are generated using access information provided by the UMTS network 104. The access information provided by the UMTS network 104 may include, for example, a temporary identifier (such as the B-TID identifier of the GBA protocol). The access information may additionally include a random value RAND, which value is used by the UE 102 to generate a security key Ks. The access information may also include a value representing the lifetime of the temporary access credentials that are generated for the UE 102 (referred to as Lifetime), an IP Multimedia Private Identity (IMPI), for example, as per the GBA specifications.

In an example arrangement, the UE 201 is authenticated with the UMTS network 104 and temporary access credentials are generated in the UE 102 and the UMTS network 104 (e.g. the BSF 122), according to the GBA specifications (see 3GPP TS 33.220). The UE 102 performs the GBA bootstrapping procedure with the BSF 122 and generates temporary access credentials (also called bootstrapped security context) with the access information received from the UMTS network according to the GBA specifications.

The temporary access credentials generated by the UE 102 may include the temporary identifier, such as the B-TID identifier of the GBA protocol, received from the UMTS network 104. The temporary access credentials may further include a security key (referred to as Ks in the GBA specifications) generated by the UE 102 using the RAND provided by the UMTS network 104. The temporary access credentials may further include access information, such as RAND from the BSF 122, a Lifetime value, and IP Multimedia Private Identity (IMPI). The temporary access credentials normally enable the UE 102 to create a security context with the UMTS network 104 so that the UE 102 is able to subsequently access services in the UMTS network 104. For example, the temporary access credentials are normally generated according to the GBA specifications so that the UE 102 is able to subsequently access IP based services including HTTP based services, in the UMTS network 104. As described in this disclosure, the UE 102 generates the temporary access credentials in order to create a security context with the WiFi network 110 (using a set of credentials used to authenticate with the UMTS network 104) for facilitating access to the WiFi network 110.

Typically, the UE 102 generates the temporary access credentials when the UE 102 attempts to access IP services (e.g. an HTTP server) that require GBA based authentication. Alternatively or additionally, as described in this disclosure, the UE 102 can generate the temporary access credentials when the UE 102 attempts to access the WiFi network 110 and requires a username and password to authenticate with this WiFi network 110.

As part of the GBA bootstrapping procedure performed with the UE 102, the BSF 122 also generates temporary access credentials. Since the information used to generate the temporary access credentials in the UE 102 and the BSF 122 is the same, the temporary access credentials generated by the UE 102 and BSF 122 are the same but are generated independently.

The UE 102, under the control of the transformation element 216, then transforms the temporary access credentials and an identifier of the WiFi network 110 (e.g. an identifier of an access point of the WiFi network 110 such as the SSID, or BSSID or HESSID), to generate first transformed access credentials, step 302. The first transformed access credentials are thus generated by the UE 102 transforming the temporary access credentials using the identifier of the WiFi network 110. The first transformed access credentials may include the temporary identifier (e.g. B-TID) received from the UMTS network 104 in step 300 and a temporary password (Ks_SSID) that can be used to access the WiFi network 110. The temporary password is generated by a transformation function (F1) that uses the temporary access credentials (e.g. such as Ks, B-TID, RAND, etc) and the identifier of the WiFi network 110 (e.g. SSID). By using the identifier of the WiFi network 110, the identity of the access point of the WiFi network (e.g. the SSID and/or the BSSID, and/or the HESSID) can be taken into account when generating access credentials for the WiFi network 110.

The UE 102 may determine the identifier of the AP 112 as part of the discovery and association procedure with the WiFi network 110. Typically, the UE 102 may detect the AP 112 as a target AP when the UE 102 is located in coverage area 114. A decision is taken to handover the UE 102 from the UTRAN 105 to the detected target AP 112 or to connect with the target AP 112 simultaneously with the existing data connection to UTRAN 105. This decision is typically made by the UE 102. The decision may be based on signal strength measurements, and/or the preferred wireless communication system of the UE 102 and/or other parameters as is well known in the art. The discovery and association procedure is well known (see, for example, IEEE 802.11 and IEEE 802.11u, the disclosure of which is incorporated herein by reference).

In an example, the UE, 102 by means of the transformation element 216, performs transforming steps on the temporary access credentials and an identifier of the WiFi network 110 which steps include combining the temporary access credentials and the identifier to provide transformed access credentials. In other words, the UE 102 uses the temporary access credentials generated during the GBA authentication procedure and the identifier of the WiFi network 110 to create another set of access credentials (referred to herein as first transformed access credentials) which can be used to access the access point of the WiFi network 110. The first transformed access credentials include a password that is derived by means of a transformation function (F1) and the identity of the WiFi network 110 (e.g. the identifier of the WiFi network). This WiFi specific password together with the temporary identifier (e.g. B-TID) that was received from the UMTS network 104 as part of the authentication step in step 300, constitute the credentials that can be used subsequently to authenticate with the WiFi network 110. The transformation performed by the function F1 under the control of transformation element 216 may include transforming the temporary access credentials, and AP identifier to provide transformed access credentials, including a username (B-TID) and a WiFi network specific password. Transforming may include concatenating the temporary access credentials and the AP identifier and performing a transformation function, such as a hash function using a security key, on the concatenated temporary access credentials and identifier to provide the transformed access credentials. The security key is typically a shared key (shared between the UE 102 and the BSF 122) generated by the UE 102 and the BSF 122 independently with GBA authentication procedure. This key is commonly referred to as Ks in the GBA specifications.

The first transformed access credentials generated by the UE 102 are then transmitted, step 304, by the UE 102 so that authentication with the WiFi network 110 using the first transformed access credentials can be performed. The first transformed access credentials are therefore used as a temporary password and username (e.g. B-TID) for authentication with the WiFi network 110.

The identifier of the WiFi network 110 is provided to the UMTS network 104, step 306 and the UMTS network (104) generates second transformed access credentials using the identifier of the WiFi network 110 and the temporary access credentials generated by the UMTS network 104 using the access information provided by the UMTS network 104, step 308. In an example, the temporary access credentials generated by the UMTS network using the access information are generated by the BSF 122 during the GBA bootstrapping procedure.

The UMTS network 104 is arranged to transform the temporary access credentials generated by the UMTS network 104 and the identifier of the WiFi network 110 to provide the second transformed access credentials. The second transformed access credentials include a password that is derived by means of a transformation function, which is the same transformation function (F1) used by the UE 102 when performing the transformation in step 302 and the identity of the WiFi network 110 (e.g. the identifier of the WiFi network). The second transformed access credentials further includes the temporary identifier (e.g. B-TID) assigned to the UE 102 by the UMTS network 104. The transformation performed by the function F1 may include (as with the UE 102 above) transforming the temporary access credentials, and AP identifier to provide transformed access credentials, including a username (B-TID) and a WiFi network specific password. Transforming may include concatenating the temporary access credentials and the AP identifier and performing a transformation function, such as a hash function using the shared security key Ks, on the concatenated temporary access credentials and identifier to provide the second transformed access credentials.

The first transformed access credentials are therefore generated by the UE 102 using the identifier of the WiFi network 110 and the temporary access credentials and the second transformed access credentials are generated by the UMTS network 104 using the identifier WiFi network and the temporary access credentials. Both the first and second transformed access credentials are generated using the same transformation function but independently.

Authentication with the WiFi network 110 is then performed, step 310. This includes comparing the first transformed access credentials with the second transformed access credentials. Access to the WiFi network 110 is allowed when the first transformed access credentials and the second transformed access credentials are the same or substantially the same.

In an example, the first transformed access credentials may be transmitted to the UMTS network 104 and the UMTS network 104 performs the authentication. For example, the UMTS network 104 receives the identifier of the AP 112 via the WAG 118 of the WiFi network 110 and the first transformed access credentials generated by the UE 102 (e.g. via the WAG 118). The UMTS network 104 (e.g. the AAA server 124) then compares or maps the received first transformed access credentials with the second transformed access credentials generated by the UMTS network 104 and if there is a match or proper mapping or the first and second transformed access credentials are the same, the UE 102 is authenticated for access to the WiFi network 110. When the first and second transformed access credentials are determined to be the same, the UMTS network 104 sends an access allowed message to the WiFi network 110 to indicated the UE 102 is authenticated for access to the WiFi network 110.

In another example, the first transformed access credentials may be transmitted by the UE 102 to the WiFi network 110 when the UE 102 attempts to access the WiFi network 110 and the WiFi network 110 performs the authentication. In this case, the WiFi network 110 (e.g. the WAG 118) also receives the second transformed access credentials for the UE 102 from the UMTS network 104. The WiFi network 110 then authenticates the UE 102 using the first transformed access credentials received from the UE 102 and the second transformed access credentials received from the UMTS network 104. For example, the WiFi network 110 then compares or maps the first transformed access credentials received from the UE 102 with the second transformed access credentials received from the UMTS network 104 and if there is a match or proper mapping or the first and second transformed access credentials are the same, the UE 102 is authenticated for access to the WiFi network 110. When the first and second transformed access credentials are determined to be the same, the WiFi network 110 sends an access allowed message to the UE 102 to indicated the UE 102 is authenticated for access to the WiFi network 110.

The method in accordance with the disclosure may be used to authenticate the UE 102 for access to the WiFi network 110 or may be used to authenticate a remote device for access to the WiFi network 110 via the UE 102.

In the first case, the UE 102 receives access information from the UMTS network 104, generates temporary access credentials, transforms the temporary access credentials and an identifier of the AP 112 and the UE 102 then transmits the transformed access credentials to either the UMTS network 104 or the WiFi network 110 so that the UE 102 may be authenticated for access to the WiFi network 110. Once authenticated for access to the WiFi network 110, the UE 102 may then set up a connection to the WiFi network 110 so that the UE 102 may communicate with the WiFi network 110 and access a service available through the WiFi network 110.

In the second case, when the UE 102 is in the proximity of or remote from a remote device and communicably coupled to the remote device (shown as device 120 in FIG. 1), the UE 102 can facilitate the authentication of the remote device 120 for accessing the WiFi network 110. The remote device 120 may be any device that does not have an UICC (e.g. no ICC) such as a portable computer or a multimedia device, or a PDA or similar device. In other words, any device that cannot run EAP-AKA and/or WISPr 2.0. The UE 102 provides the first transformed access credentials (e.g. temporary password and username) to enable the remote device 120 to be authenticated for access to the WiFi network 110 via AP 112. The UE 102 may be communicably coupled to the remote device 120 via a Bluetooth communication link or connection, hard wire connection, WLAN or any other types of connection or communication link. The UE 102 may also be remote from the remote device 120 and the UE 102 is communicably coupled to the remote device 120 via a special DNS server (not shown). When the UE 102 is communicably coupled to the remote device 120 via a DNS server, the UE 102 communicates with the remote device using DNS queries sent, for example, via the WiFi network 110. Once authenticated for access to the WiFi network 110, the remote device 120 may then set up a connection to the WiFi network 110 so that the remote device 120 may communicate with the WiFi network 110 and access a service available through the WiFi network 110.

In this second case, the UE 102 may receive a request from the remote device 120 to access the WiFi network 110. The request includes the identifier of the WiFi network 110 (e.g. the identifier of the AP 112). The UE 102 generates temporary access credentials using access information from the UMTS network 104 as before and uses the identifier of the AP 112 received from the remote device 120 and the temporary access credentials to provide first transformed access credentials for use in performing authentication for the remote device 120 with the WiFi network 110. The UE 102 then transmits the first transformed credentials to the remote device 120 so that the remote device 120 may transmit the transformed credentials to either the UMTS network 104 or the WiFi network 110 so that the remote device 120 may be authenticated for access to the WiFi network 110. Once authenticated for access to the WiFi network 110, the remote device 120 may then set up a connection to the WiFi network 110 so that the remote device 120 may communicate with the WiFi network 110 and access a service available through the WiFi network 110.

Thus, in this second case, the method in accordance with the disclosure allows a remote device that does not possess a UICC card to authenticate against a WiFi network by delegating credential generation to the UE or other device that does possess a UICC card.

When the UE 102 is communicably coupled to the remote device 120 by means of a special DNS server, although the remote device 120 is not yet authenticated with the WiFi network 110, the remote device 120 may be able to send DNS queries through the WiFi network 110 and receive responses. This is typically the case today with public WiFi hotspots that do not utilise air-interface encryption. In this example, the remote device 120 sends a special DNS request that contains the identifier (SSID) of the AP 112 and which is routed to the special DNS server. The special DNS server is configured to send the received SSID to the UE over the UMTS network 104. The UE 102 then runs the bootstrapping procedure and responds to the special DNS server with the first transformed access credentials (including e.g. temporary username (B-TID) and password (Ks_SSID)). The special DNS server responds to the DNS query from the remote device 120 with a message that includes the first transformed access credentials e.g. temporary username (B-TID) and password (Ks_SSID) so that the remote device may be authenticated to access the WiFi network 110.

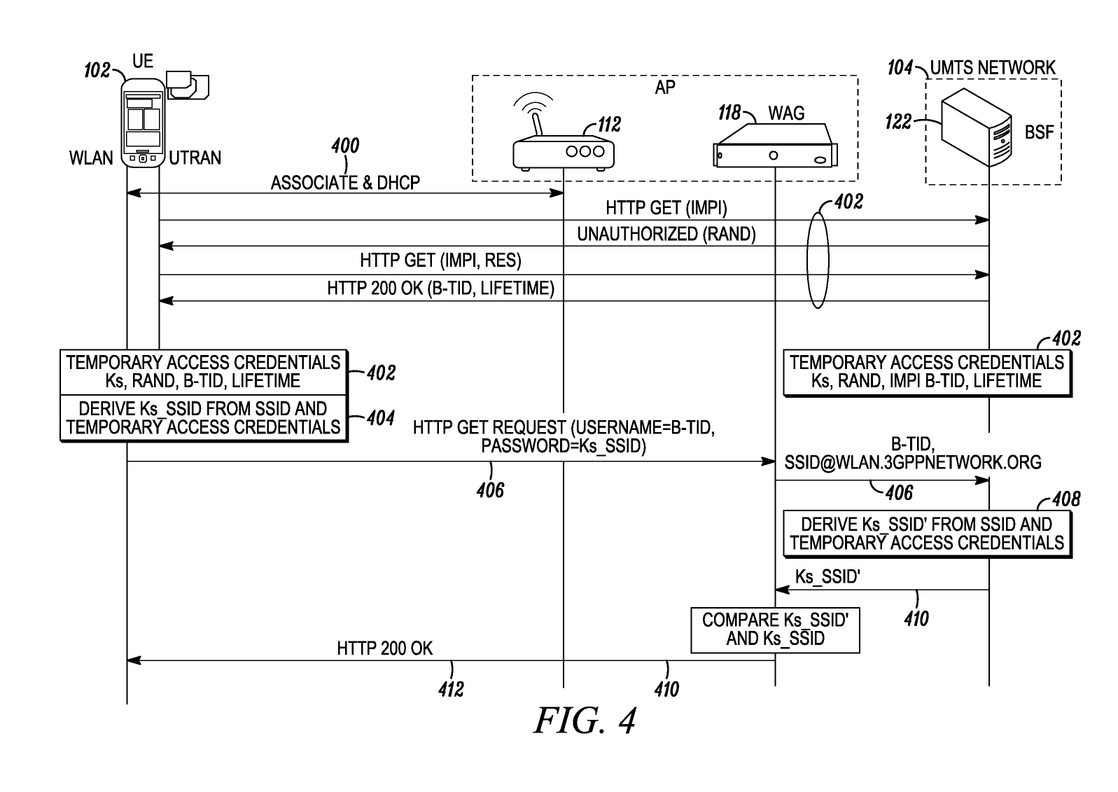

Referring now to also to FIG. 4, which shows an example message flow for the method in accordance with an embodiment of the disclosure when a UE 102 is attached to the UMTS network 104 (i.e. the UE 102 is authenticated and authorised to access the UMTS network 104 but may or may not be connected and exchanging data) and the UE enters the coverage area 114 of the AP 112 of the WiFi network 110.

The UE 102 discovers and associates with the AP 112, step 400. During this process, the UE determines the identifier (SSID) for the AP 112. The UE 102 then triggers and performs the BGA bootstrapping procedure over the UMTS interface under the control of the processing unit 202, steps 402. For example, a BGA client in program memory 214 is called and run in response to detecting AP 112. This requires the use of the UICC 224. As a result, a bootstrapped security context is created in the UE 102 (e.g. stored in memory 218) and in the BSF 122, including a security key (Ks), a temporary identifier in the form of a bootstrap temporary ID (B-TID), and access information including RAND, IMPI, and Lifetime. The RAND, B-TID and Lifetime are communicated from the BSF 122 to the UE 102 as access information. The security key Ks are independently created in the UE 102 and BSF 122 with a USIM-AKA authentication algorithm.

During the bootstrapping procedure, the UE 102 identifies itself with IMPI or Temporary IMS Private Identify (TMPI). The IMPI is stored in ISIM, e.g. tobias_private@homel.fr. If there is no ISIM, then TMPI is used. The TMPI is derived from IMSI as per 3GPP TS 23.003 (the disclosure of which is incorporated herein by reference). For example, 234150999999999@ims.mnc015.mcc234.3gppnetwork.org.

For 3GPP2 systems, the UE derives the private user identity as per Annex C of X.S0013-004 as described in 3GPP TS 23.003, the disclosure of which is incorporated herein by reference.

After the security context for the UE 102 is created (e.g. the temporary access credentials have been generated by the UE 102 and the UMTS network 104 in step 402), the UE 102 transforms the temporary access credentials (e.g. B-TID, RAND, IMPI) and the SSID of the AP 112 to provide first transformed access credentials, steps 404. For example, the UE derives the following transformed data from the temporary access credentials and the SSID of the AP 112 and a derivation function (e.g. a hash function):

Ks_SSID=HMAC-SHA-256 (Ks, “gba_me”|IMPI|RAND|SSID_Id)

### Where

“gba_me” is a string value
RAND is random value from BSF
   | is a concatenate operator
SSID_Id=<SSID_value>.bsf.3gppnetwork.org
<SSID_value>—SSID without white spaces

The first transformed access credentials includes the temporary identifier, B-TID, and the transformed data, Ks_SSID, which are used by the UE 102 as a temporary username and password, respectively, to authenticate the UE 102 with the AP 112. The B-TID is received from the BSF and has the form of NAI: B-TID=base64encode(RAND)@BSF_servers_domain_name, e.g. B-TID=6629fae49393a0539745@bsf.operator.com.

The UMTS network 104 receives the SSID of the AP 112 via the WAG 118, step 406. The UMTS network 104 also transforms the temporary access credentials (e.g. B-TID, RAND, IMPI, Ks, Lifetime) generated by the BSF 122 and the SSID of the AP 112 to provide second transformed access credentials Ks_SSID′, step 408. The second transformed access credentials are generated using the same function as used to generate the first transformed access credentials.

The UE 102 starts the WLAN authentication by invoking its WISPr 1.0 client (e.g. stored in program memory 214). The WAG 118 functions as a RADIUS client treating B-TID and Ks_SSID as username and password respectively. The WAG 118 communicates with the AAA server 124 in the home network which then interfaces to BSF 122. The WAG 118 confirms that the temporary password Ks_SSID returned by the UE 102 in the first transformed access credentials matches the temporary password Ks-SSID′ returned by the home network (in the case of FIG. 1, UMTS network 104) in the second transformed access credentials, steps 410. The UE 102 is then authenticated for access to the WiFi network 110, step 412.

The WAG 118 routes RADIUS messages based on username as usual. The AAA server 124 functions as a Network Application Function (NAF) and implements Zn interface towards BSF (as per 3GPP Technical Specification (TS) 33.220). The AAA Server 124 sends B-TID and SSID_Id to BSF 122, which then derives Ks_SSID′ by using the stored bootstrapped security context indexed by B-TID and the same derivation function, i.e. HMAC-SHA-256 (Ks, “gba-me”∥RAND∥IMPI∥SSID_Id). If the UE 102 and BSF 122 share the same Ks and implement the same derivation function (e.g. the same hash function), then they will both generate the same temporary password Ks_SSID. So, the AAA server 124 will be able to match the temporary password Ks_SSID received in the RADIUS Access-Request and the temporary password Ks_SSID returned by BSF 122, and will thus authenticate and authorize the UE 102 to access the WiFi AP 112.

The UE 102 therefore executes a bootstrapping procedure, as per 3GPP Technical Specification (TS) 33.220, the disclosure of which is incorporated herein by reference, to create a new security context (shared between the network (BSF) and the UE) and uses the access credentials created as part of the new security context and received from the UMTS network 104 and the identifier of the AP to derive a temporary username and password. Subsequently, the UE uses a WISPr 1.0 client to authenticate over WiFi with the temporary username and password.

Thus, an advantage of this aspect of the method in accordance with the disclosure is that it requires no changes to the WiFi AP or hotspot. Any changes are made in the network, e.g. an AAA server of the home network implements a Zn interface towards a BSF, as per 3GPP Technical Specification (TS) 33.220, the disclosure of which is incorporated herein by reference. Thus, compared to EAP-AKA and WISPr 2.0, the method in accordance with the disclosure can be deployed with no changes to the WiFi AP or hotspot and it does not require any extra complexity in the UE.

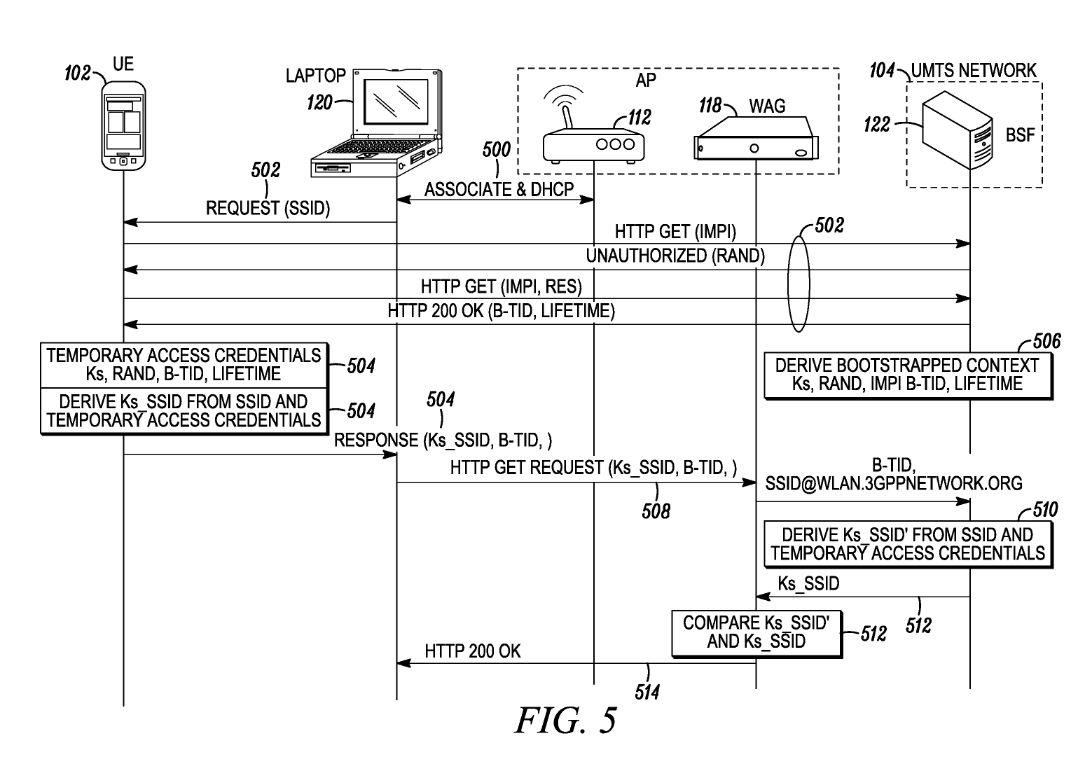

Referring now to also to FIG. 5, which shows an example message flow for the method in accordance with an embodiment of the disclosure when a UE 102 is attached to the UMTS network 104 (i.e. the UE 102 is authenticated and authorised to access the UMTS network 104 but may or may not be connected and exchanging data) and a remote device 120 (shown in FIG. 5 as a portable computer or lap top) enters the coverage area 114 of the AP 112 of the WiFi network 110 and requests access to the WiFi network 110. The UE 102 may be remote or in the vicinity of the portable computer 120 but is communicably coupled to the portable computer 120 (e.g. via a Bluetooth communication link or other short-range wireless technology or by any other means).

The portable computer 120 discovers a new AP 112 that supports GBA authentication, and associates with the AP and retrieves IP configuration data with Dynamic Host Configuration Protocol (DHCP), step 500. However, the portable computer 120 is not equipped with UICC so cannot run EAP-AKA and/or WISPr 2.0. The portable computer 120 sends a request to the UE 102 (e.g. over the Bluetooth communication link or other short-range wireless technology or by any other means) to request access credentials to access the AP 112. The request includes the identifier of the AP 112. The receipt of the request at the UE 102 triggers the UE 102 to perform the GBA bootstrapping procedure over its UMTS interface (if no bootstrapped context exists already), as per 3GPP Technical Specification (TS) 33.220, the disclosure of which is incorporated herein by reference. This requires the use of UICC 224, steps 502. As a result, access information, including B-TID, RAND, Lifetime, are provided to the UE 102. The RAND, B-TID and Lifetime are communicated from the BSF 122 to the UE 102. The UE 102 generates temporary access credentials including a temporary identifier (B-TID) and a security key, Ks. Security key Ks are independently created in the UE 102 and BSF 122 with a USIM-AKA authentication algorithm. The UMTS network 104 also generates temporary access credentials according to the GBA bootstrapping procedure, step 506.

The UE 102 transforms the temporary access credentials and AP identifier to provide first transformed access credentials, steps 504. For example, the UE derives transformed data using a derivation function (e.g. a hash function) as above:

Ks_SSID=HMAC-SHA-256 (Ks, “gba_me”|IMPI|RAND|SSID_Id)

The UE 102 returns the transformed access credentials Ks_SSID, B-TID to the portable computer 120, steps 504 (e.g. over the Bluetooth communication link).

The portable computer 120 starts the WLAN authentication (e.g. using WISPr 1.0) and sends the first transformed access credentials received from the UE 102 (including the bootstrapped context) to the WAG 118, steps 508.

The UMTS network 104 receives the SSID of the AP 112 via the WAG 118, steps 510. The UMTS network 104 also transforms the temporary access credentials (e.g. B-TID, RAND, IMPI, Ks, Lifetime) generated by the BSF 122 and the SSID of the AP 112 to provide second transformed access credentials Ks_SSID′, steps 510. The second transformed access credentials are generated using the same function as used to generate the first transformed access credentials.

The WAG 118 functions as a Network Application Function (NAF). The WAG 118 confirms that the Ks_SSID returned by the portable computer 120 matches the Ks-SSID′ returned by the BSF 122 of the UMTS network 104, steps 512. The portable computer 120 is then authenticated for access to the WiFi network 110, step 514.

In this aspect, the method in accordance with the disclosure enables a first device (e.g. a portable computer) without a UICC card to connect to a new WiFi network by using the GBA security context created by a second device (e.g. a UE) which has a UICC card.

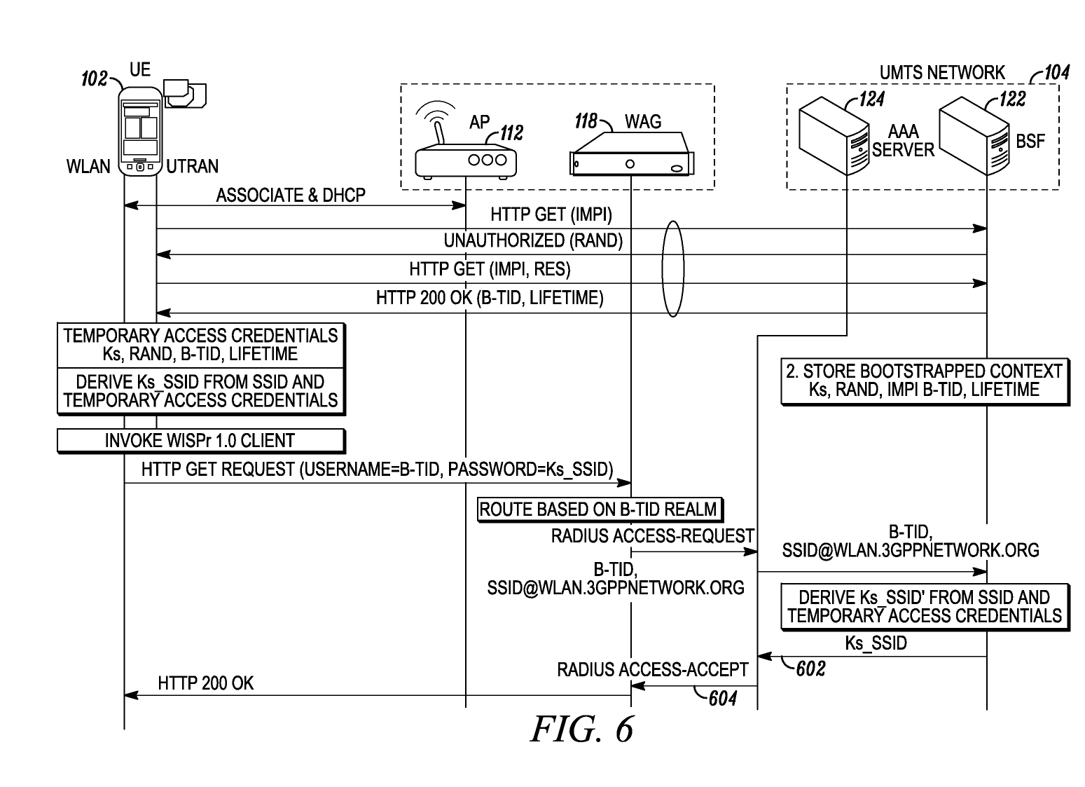

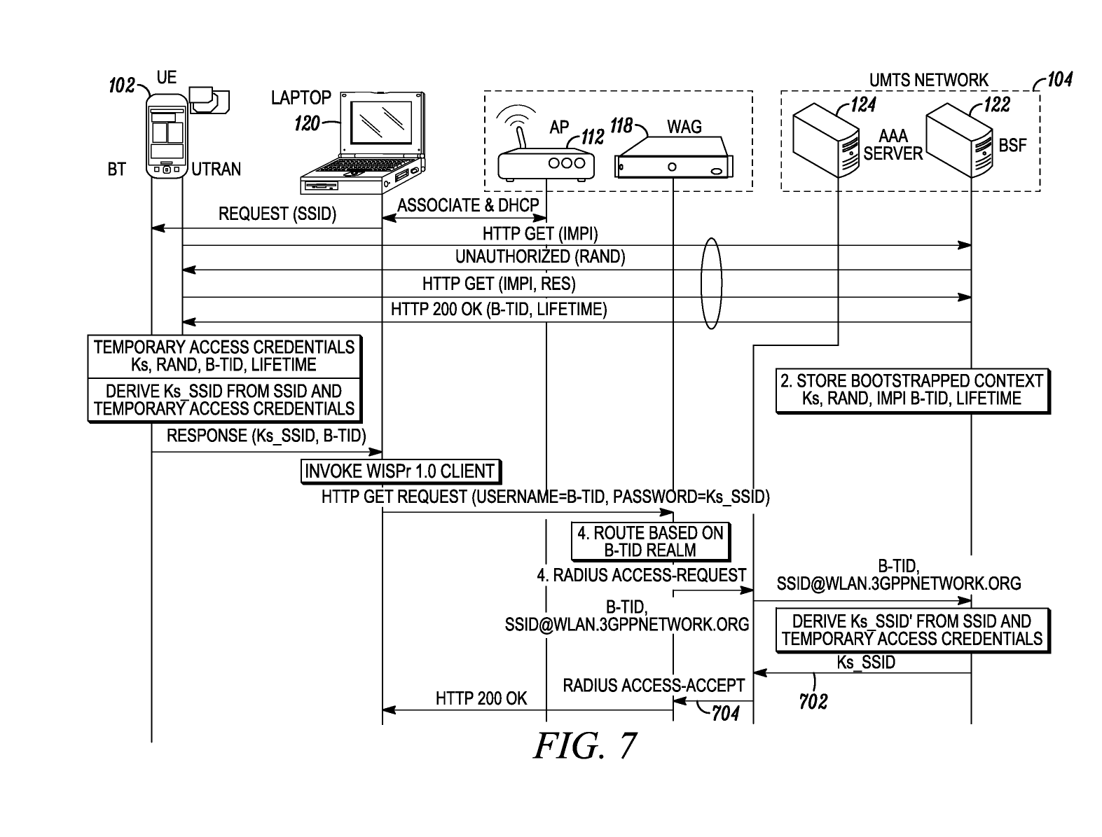

Referring now also to FIGS. 6 and 7. FIG. 6 is similar to FIG. 4 except that the comparison of the temporary password Ks_SSID of the first transformed access credentials generated by the UE 102 and the temporary password Ks_SSID′ of the second transformed access credentials generated by the UMTS network 104 is performed in the UMTS network 104 (e.g. by the AAA server 124), step 602. When the temporary passwords match or are the same, the UMTS network 104 sends an access allowed (RADIUS Access-Accept) message to the WAG 118, step 604, to indicate that the UE 102 is authenticated to access the WiFi network 110. Thus, the description of FIG. 4 above applies similarly to FIG. 6. With the example method in accordance with the disclosure and as represented by the message flow in FIG. 6, the WAG 118 does not receive any sensitive information from the UMTS network 104 (e.g. the temporary password Ks_SSID′) and so, as compared with the example method in accordance with the disclosure and as represented by the message flow of FIG. 4, it is more secure and less vulnerable to security attacks.

FIG. 7 is similar to FIG. 5 except that the comparison of the temporary password Ks_SSID of the first transformed access credentials generated by the UE 102 and the temporary password Ks_SSID′ of the second transformed access credentials generated by the UMTS network 104 is performed in the UMTS network 104 (e.g. by the AAA server 124), step 702. When the temporary passwords match or are the same, the UMTS network 104 sends an access allowed (RADIUS Access-Accept) message to the WAG 118, step 704, to indicate that the remote device 120 is authenticated to access the WiFi network 110. Thus, the description of FIG. 5 above applies similarly to FIG. 7. With the example method in accordance with the disclosure and as represented by the message flow in FIG. 7, the WAG 118 does not receive any sensitive information from the UMTS network 104 (e.g. the temporary password Ks_SSID′) and so, as compared with the example method in accordance with the disclosure and as represented by the message flow of FIG. 5, it is more secure and less vulnerable to security attacks.

In summary, the method in accordance with the present disclosure uses access information received from the UMTS network and an identifier of the WiFi network to which the UE wishes to connect to derive transformed access credentials (e.g. temporary username and password) for use in performing authentication with the first access network to facilitate access to the first access network (by the UE or a remote device).

Since an identifier of the WiFi network is used to provide the transformed access credentials (e.g. temporary password) which are used to authenticate with the WiFi network, the security of the disclosed access method is improved compared to the known GBA related access method since the temporary password used to authenticate depends on a characteristic of the WiFi network.

Thus, in an example arrangement, GBA used for authenticating the UE to the UMTS network can be reused for WiFi authentication too. This simplifies the implementation in the UE of seamless user access to a WiFi network since the UE already implements GBA and ensures security by using GBA and secure credentials stored in the UICC of the UE.

Since the method in accordance with the present disclosure uses access information received from the UMTS network to generate the necessary access credentials to access the WiFi network (without the need to use EAP-AKA), there is no need to upgrade existing APs so that they can support EAP and Radius. Existing APs can be re-used.

In an example arrangement, the method in accordance with the disclosure may enable a UICC-less device to authenticate and connect to a WiFi AP or hotspot by exploiting the UICC-based access credentials generated by a UE which possesses a UICC card and by means of a simple request/response protocol. In this way, the UICC-less device does not need any manual configuration or provisioning before attaching to a WiFi hotspot and without the additional complexity of implementing EAP-AKA and/or WISPr 2.0 and without any need to upgrade any element in the WiFi AP. Thus, the UICC-less device benefits from receiving the transformed access credentials (e.g. temporary user name and password) from a trusted device that is equipped with a UICC and is capable of performing the GBA bootstrapping procedure to create a bootstrapped security context.

The present disclose has been described with respect to a public WiFi network with WiFi hotspots, such as WiFi networks provided by corporations, small businesses, non-profit institutions, government bodies, academic campus', airports, shopping centres or similar environments. It will be appreciated that the present invention may apply to home or residential WiFi networks or home WLAN provided home network has interworking for communicating with the UMTS network (e.g. to obtain access credentials for the UE to access the home network and/or to communicate with the UMTS network to authenticate the UE on the home network).

In the foregoing specification, the invention has been described with reference to specific examples of embodiments of the invention. It will, however, be evident that various modifications and changes may be made therein without departing from the broader scope of the invention as set forth in the appended claims.

Some of the above embodiments, as applicable, may be implemented using a variety of different processing systems. For example, the Figures and the discussion thereof describe an exemplary architecture which is presented merely to provide a useful reference in discussing various aspects of the disclosure. Of course, the description of the architecture has been simplified for purposes of discussion, and it is just one of many different types of appropriate architectures that may be used in accordance with the disclosure. Those skilled in the art will recognize that the boundaries between program and system/device elements are merely illustrative and that alternative embodiments may merge elements or impose an alternate decomposition of functionality upon various elements.

1. A method for facilitating access to a first access network of a wireless communication system, the method comprising:
authenticating a wireless communication device with a second access network and generating temporary access credentials using access information provided by the second access network;
transforming by the wireless communication device the temporary access credentials and an identifier of the first access network to provide first transformed access credentials; and
transmitting the first transformed access credentials for performing authentication with the first access network;
providing the identifier of the first access network to the second access network and generating by the second access network second transformed access credentials using the identifier of the first access network and the temporary access credentials; and
performing authentication with the first access network, including comparing the first transformed access credentials with the second transformed access credentials and allowing access to the first access network when the first transformed access credentials and the second transformed access credentials are substantially the same.

2. The method of claim 1, wherein the temporary access credentials include a temporary identifier for the wireless communication device.

3. The method of claim 2, wherein transforming includes performing a transformation function on the temporary access credentials and the identifier of the first access network to provide a first password, wherein the first transformed access credentials include the temporary identifier and the first password.

4. The method of claim 3, wherein generating by the second access network second transformed access credentials includes performing the transformation function on the temporary access credentials and the identifier of the first access network provided to the second access network to provide a second password, wherein the second transformed access credentials include the temporary identifier and the second password.

5. The method of claim 1, further including receiving at the second access network the first transformed access credentials, wherein comparing is performed by the second access network, and when the first and second transformed access credentials are substantially the same, sending by the second access network an access allowed message to the first access network.

6. The method of claim 1, further including receiving at the first access network the first transformed access credentials and the second transformed access credentials, wherein comparing is performed by the first access network, and when the first and second transformed access credentials are substantially the same, allowing by the first access network access to the first access network.

7. The method of claim 1, wherein the wireless communication device is authenticated with the first access network using the transformed access credentials for allowing the wireless communication device to access the first access network.

8. The method of claim 1, further comprising receiving at the wireless communication device a request from a remote device to access the first access network, the request including the identifier of the first access network, wherein transforming includes transforming the temporary access credentials and the identifier of the first access network received from the remote device to provide first transformed access credentials and wherein transmitting includes transmitting the first transformed access credentials for performing authentication of the remote device with the first access network using the transformed access credentials for allowing the remote device to access the first access network.

9. A method in a wireless communication device for facilitating access to a first access network, the method comprising:
authenticating the wireless communication device with a second access network and generating temporary access credentials using access information provided by the second access network;
transforming by the wireless communication device the temporary access credentials by using an identifier of the first access network to provide first transformed access credentials; and
transmitting by the wireless communication device the first transformed access credentials for performing authentication with the first access network to allow access to the first access network.

10. A wireless communication system including a first access network and a second access network and at least one wireless communication device, the system being arranged to facilitate access to the first access network:
the wireless communication device and second access network being arranged to generate temporary access credentials using access information provided by the second access network for authenticating the wireless communication device with the second access network;
the wireless communication device including:
a transformation element for transforming the temporary access credentials and an identifier of the first access network to provide first transformed access credentials; and
a transmitter for transmitting the first transformed access credentials for performing authentication with the first access network;
the second access network being arranged to receive the identifier of the first access network and to generate second transformed access credentials using the identifier of the first access network and the temporary access credentials; and
an element of the wireless communication system being arranged to compare the first transformed access credentials with the second transformed access credentials and to allow access to the first access network when the first transformed access credentials and the second transformed access credentials are substantially the same.

11. The wireless communication system of claim 10, wherein the temporary access credentials include a temporary identifier for the wireless communication device.

12. The wireless communication system of claim 11, wherein the transformation element is arranged to perform a transformation function on the temporary access credentials and the identifier of the first access network to provide a first password, wherein the first transformed access credentials include the temporary identifier and the first password.

13. The wireless communication system of claim 12, wherein the second access network is arranged to perform the transformation function on the temporary access credentials and the identifier of the first access network received at the second access network to provide a second password, wherein the second transformed access credentials include the temporary identifier and the second password.

14. The wireless communication system of claim 10, wherein the second access network is arranged to receive the first transformed access credentials, and wherein the element is the second access network, and when the first and second transformed access credentials are determined to be substantially the same by the second access network, the second access network is arranged to send an access allowed message to the first access network.

15. The wireless communication system of claim 10, wherein the first access network is arranged to receive the first transformed access credentials and the second transformed access credentials, wherein the element is the first access network, and when the first and second transformed access credentials are determined to be substantially the same by the first access network, the first access network is arranged to allow access to the first access network.

16. The wireless communication system of claim 10, wherein the wireless communication device is authenticated with the first access network using the transformed access credentials for allowing the wireless communication device to access to the first access network.

17. The wireless communication system of claim 10, further comprising a remote device communicably coupled to the wireless communication device,
the wireless communication device being arranged to receive a request from the remote device to access the first access network, the request including the identifier of the first access network, wherein the transformation element of the wireless communication device is arranged to transform the temporary access credentials and the identifier of the first access network received from the remote device to provide first transformed access credentials and wherein the transmitter of the wireless communication device is arranged to transmit the first transformed access credentials for performing authentication of the remote device with the first access network using the first transformed access credentials for allowing the remote device to access the first access network.

18. A wireless communication device for facilitating access to a first access network of a wireless communication system including the first access network and a second access network:
the wireless communication device being arranged to authenticate with the second access network and to generate temporary access credentials using access information provided by the second access network;
the wireless communication device including:
a transformation element for transforming the temporary access credentials and an identifier of the first access network to provide first transformed access credentials; and
a transmitter for transmitting the first transformed access credentials for performing authentication with the first access network to allow access to the first access network.
